(19) United States
(12) Patent Application Publication
(10) Pub. No.: US 2011/0149334 A1
(43) Pub. Date: Jun. 23, 2011

(54) METHODS AND SYSTEMS FOR PROCESSING A PRINT JOB IN A PRINT SHOP

(75) Inventors: Drew D. Saur, Rochester, NY (US); Sudhendu Rai, Fairport, NY (US)

(73) Assignee: XEROX CORPORATION, Norwalk, CT (US)

(21) Appl. No.: 12/640,871

(22) Filed: Dec. 17, 2009

(51) Int. Cl. G06F 3/12

(52) U.S. Cl. 358/1.15

(57) ABSTRACT

A system for processing a print job in a print production environment may include a plurality of print production devices in a production line, a computing device in communication with the one or more print production devices and a computer readable storage medium in communication with the computing device. The computer readable storage medium may include one or more programming instructions for identifying a processing rate and a buffer size for a first upstream print production device in the production line, and determining an effect on a second upstream print production device in the production line if a downstream print production device associated with a downstream function exhibits a delay condition. The computer readable storage medium may include one or more programming instructions for performing a modification to the production line such that implementation of the modification reduces the effect.

### TECHNICAL FIELD

This application relates to methods and systems for processing a job in a production environment, and more specifically to methods and systems for processing a print job in a print shop.

### BACKGROUND

Conventional print shops usually employ a production line having a series of stations that sequentially perform functions on a print job. For example, the production of a book in a print shop may entail printing at one station, cover collation at a separate station and plastic comb binding at a third station. Workflow systems for coordinating the production of document processing jobs among different document production devices are know in the art and are described in at least U.S. Pat. No. 7,051,328 to Rai et al. and U.S. Pat. No. 7,065,567 to Squires et al.

However, failures or delays of a downstream function can affect the processing speed and throughput of an upstream function. For example, the failure of a downstream collator will affect the operation of any preceding upstream functions in a function sequence, which will lead to significant time delays.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a system for processing a print job in a print production environment may include a plurality of print production devices in a production line, a computing device in communication with the one or more print production devices and a computer readable storage medium in communication with the computing device. The computer readable storage medium may include one or more programming instructions for identifying a processing rate and a buffer size for a first upstream print production device in the production line and determining an effect on a second upstream print production device in the production line if a downstream print production device associated with a downstream function exhibits a delay condition. The first upstream print production device may be associated with a first upstream function, and the second upstream print production device may be associated with a second upstream function. The effect may be influenced by the processing rate and the buffer size of the first upstream print production device. The computer readable storage medium may include one or more programming instructions for performing a modification to the production line such that implementation of the modification reduces the effect.

In an embodiment, a method of processing a print job in a print production environment may include identifying a processing rate and a buffer size for a first upstream print production device in a production line, and determining an effect on a second upstream print production device associated with a second upstream function if a downstream print production device associated with a downstream function exhibits a delay condition. The first upstream print production device may be associated with a first upstream function, and the effect may be influenced by the processing rate and the buffer size of the first upstream print production device. The method may include performing a modification to the production line such that implementation of the modification reduces the effect.

### BRIEF DESCRIPTION OF THE DRAWINGS

Aspects, features, benefits and advantages of the present invention will be apparent with regard to the following description and accompanying drawings, of which:

FIG. 1 illustrates an exemplary function sequence according to an embodiment.

FIG. 2 illustrates an exemplary function sequence in a print shop according to an embodiment.

FIG. 3 illustrates an exemplary method of processing a print job according to an embodiment.

FIG. 4 illustrates an exemplary production line according to an embodiment.

FIG. 5 depicts a block diagram of exemplary internal hardware that may be used to contain or implement program instructions according to an embodiment.

FIG. 6 illustrates an exemplary system for processing a print job according to an embodiment.

### DETAILED DESCRIPTION

For purposes of the discussion below, a “job” refers to a logical unit of work that is to be completed for a customer. For example, a job may include pages, batches, units and/or the like. A job may include one or more print jobs from one or more clients. Although the disclosed embodiments pertain to document production environments, the disclosed methods and systems can be applied to production systems in general.

A “print job” refers to a job processed in a document production environment. For example, a print job may include producing credit card statements corresponding to a certain credit card company, producing bank statements corresponding to a certain bank, printing a document or the like.

A “function” refers to an operation performed on a print job. For example, functions may include printing, binding, collating, stapling and/or the like.

A “print production device” refers to a machine or device used to process at least a portion of a print job. Exemplary document production devices may include printers, binders, inserters, collators and/or the like.

A “production line” includes one or more document production devices that process at least a portion of a print job sequentially.

A “print shop” refers to a production environment that processes print jobs. A print shop may be a freestanding entity, including one or more document production devices, or it may be part of a corporation or other entity. Additionally, a print shop may communicate with one or more servers by way of a local area network or a wide area network, such as the Internet, the World Wide Web or the like.

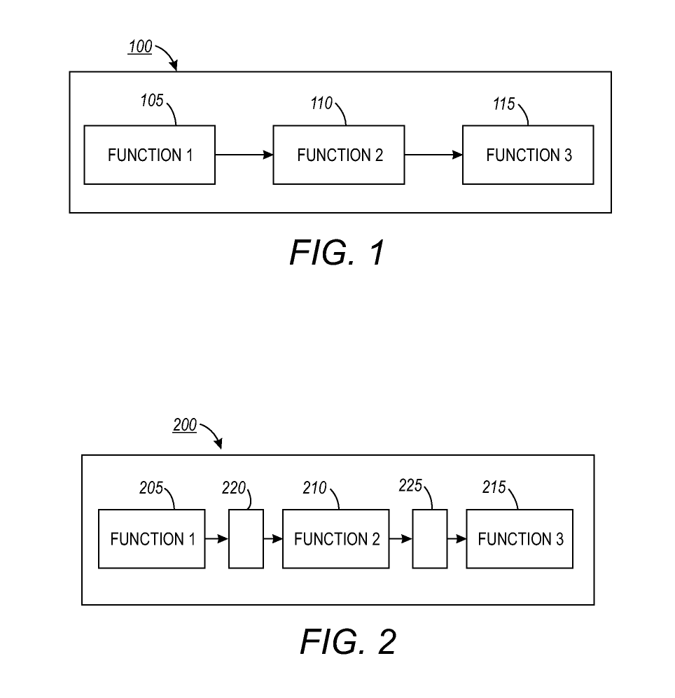

FIG. 1 illustrates an exemplary function sequence according to an embodiment. In an embodiment, a function sequence may include one or more functions to be applied to a print job. For example, FIG. 1 illustrates a function sequence 100 having three functions 105, 110, 115. In an embodiment, the functions 105, 110, 115 in the function sequence may be applied sequentially to a print job. For example, if a print job comprises a book, the first function 105 in a corresponding function sequence may be printing, the second function 110 may be collating, and the third function 115 may be binding.

In an embodiment, a print production device may perform one or more functions on a print job. For example, a printer may perform a printing function, a collator may perform a collating function and/or the like. In an embodiment, a print production device may perform more than one function. For example, a print production device may print pages of a print job and may staple the pages. As such, each print production device in a production line may correspond to one or more functions in a function sequence.

In an embodiment, functions may be applied sequentially to a print job. Alternatively, the print job may be split into one or more batches. One or more functions may be performed serially and sequentially on each batch by the print production devices in a production line.

In an embodiment, a downstream function may be a function that is applied to at least a portion of a print job after another function in a function sequence has already been performed. For example, referring to FIG. 1, the second function 110 may be considered a downstream function because it is applied to a print job after the first function 105 is applied. In an embodiment, a downstream print production device may be a print production device in a production line that corresponds to one or more downstream functions.

In an embodiment, an upstream function may be a function that is applied to a print job prior to the application of another function in a function sequence. In other words, when comparing two functions, an upstream function occurs prior to a downstream function. For example, referring to FIG. 1, the second function 110 may also be considered an upstream function because it is applied to a print job prior to the application of the third function 115. In an embodiment, an upstream print production device may be a print production device in a production line that corresponds to one or more upstream functions.

In an embodiment, one or more functions in a function sequence may be associated with a buffer. A buffer may be a tray, a shelf or other holding area that may receive the output from a print production device after a function is applied. In an embodiment, a buffer may temporarily hold at least a portion of a print job until the next function in the function sequence is applied. FIG. 2 illustrates an exemplary function sequence 200 in a print shop having functions 205, 210, 215 and buffers 220, 225 according to an embodiment.

In an embodiment, each buffer may have a corresponding buffer size. A buffer size may represent the capacity of an associated buffer. In an embodiment, a buffer size may be measured in units of output received by the buffer from a print production device associated with a corresponding print production device. For example, referring to FIG. 2, if the first function 205 is printing, the capacity of its associated buffer 220 may be measured in pages. Similarly, if the second function 210 is binding, the capacity of its associated buffer 225 may be measured in books.

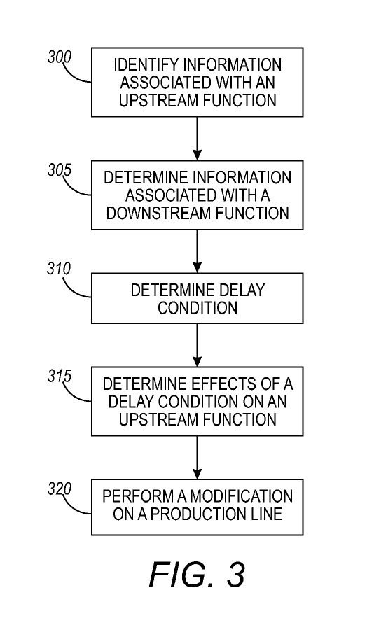

FIG. 3 illustrates an exemplary method of processing a print job according to an embodiment. As illustrated by FIG. 3, information associated with an upstream function in a function sequence may be identified 300. In an embodiment, a processing speed and buffer capacity associated with a print production device corresponding to an upstream function may be identified 300. A processing speed may include an amount of time required by a print production device to perform a function on a unit of a print job. For example, a processing rate associated with a printer may be measured in pages printed per minute. Similarly, a processing rate associated with a binder may be in books bound per hour. In an embodiment, a processing rate and/or a buffer capacity may be received directly from one or more of the print production devices. Alternatively, the processing rate and/or buffer capacity may be received from one or more computing devices, users and/or the like.

In an embodiment, information associated with a downstream function in a function sequence may be determined 305. In an embodiment, a processing speed and a delay condition may be determined 305 for a print production device corresponding to a downstream function. A delay condition may be an event that reduces the processing speed and/or increases the processing time associated with the print production device's performance of a function on a print job. For example, failure of a print production device may be a delay condition. Similarly, a paper jam, an empty media tray, low toner and/or other malfunctions may be delay conditions.

As discussed above, a print production device may perform more than one function. In an embodiment, the performance of one function may delay the performance of another function by the same print production device. For example, a print production device may perform printing and stapling functions. When the print production device is stapling, it may be unable to print. As such, this may be a delay condition associated with the print function.

This situation may be illustrated by Table 1, which shows a comparison of processing times associated with processing two different 9,000 page print jobs on a print processing device capable of performing both printing and stapling functions. Print job characteristics associated with the print jobs may be as follows:
Print job size: 9,000 pages
Printing speed: 180 pages/minute=3 pages/second
Pricing: $0.10 per page
   $0.02 per staple
   $1 per minute
Delay condition: Stapling takes two second per unit and printing must stop during this time

TABLE 1

| | Print Job Scenario 1 | Print Job Scenario 2 |
|---|---|---|
| Print job | 1,000 copies of a 9 page document | 10 copies of a 900 page document |
| Processing time for 1 unit | $\frac{9 pages}{3 pages \text{/} sec} + 2 seconds = 5 seconds$ | $\frac{900 pages}{3 pages \text{/} sec} + 2 = 302 seconds$ |
| Total | 1,000 copies * 5 seconds = 5,000 | 10 copies * 302 seconds = 3,020 |
| processing | seconds~83.33 minutes | seconds~50.33 minutes |
| time | | |

As illustrated by Table 1, the function sequence slows down as the stapling function is executed more often. In turn, this affects the processing time of the print job.

In an embodiment, a delay condition may be determined 310 based on the function being performed by the print production device. In an embodiment, delay conditions associated with one function may differ from those associated with another function. For example, delay conditions associated with printing by a printer may include insufficient paper in a paper tray, low or insufficient toner, a paper jam and/or the like. Delay conditions associated with a print production device performing stapling may include insufficient staples, a staple malfunction, a staple jam and/or the like.

In an embodiment, a delay condition may be determined 310 based on the type of print production device performing a function. A type of a print production device may include a make associated with the print production device, a model associated with the print production device, one or more functions that are performable by the print production device and/or the like. For example, certain makes or models of a print production device may correspond to one or more delay conditions. A print production device that is only a printer may correspond to certain delay conditions associated with printing, while a document production device that is a printer and scanner may correspond to delay conditions associated with printing and scanning. Additional and/or alternate functions may be performed by a print production device within the scope of this disclosure.

In an embodiment, a delay condition may be determined 310 using historical data. For example, historical data associated with a function and/or a print production device performing the function may be obtained. In an embodiment, historical data may be obtained from one or more print production devices, a user, a computing device and/or the like. Delay conditions may be determined 310 for a function and/or print production device based on delay conditions that have been experienced in the past.

In an embodiment, one or more effects of a delay condition on an upstream function may be determined 315. The occurrence of a delay condition at a downstream function may impact the operation of one or more upstream functions. For example, referring to FIG. 2, if the third function 215 experiences a delay condition, the third function may not be able to be applied to input from the second function 210. This, in turn, may impact the performance of the print production device associated with the second function 210. For example, the second function 210 may be applied to a print job until its associated buffer 225 is filled to capacity. Once this occurs, the second function 210 may be halted. Similarly, the print production device associated with the second function 210 may refuse to accept a print job from a preceding print production device because there is no availability for output in the associated buffer 220.

In an embodiment, an effect of a delay condition on an upstream function device may be influenced by the processing rate and/or the buffer size of a preceding upstream function. For example, referring to FIG. 2, the occurrence of a delay condition by the third function 215 may have an effect on an upstream function, such as the second function 210. For instance, the failure of the print production device associated with the third function 215 may force the print production device associated with the second function 210 to process a print job until the associated buffer 225 reaches its capacity. At this time, the print production device associated with the second function 210 may also stop operation. This effect may be influenced by the processing rate and/or buffer size of another upstream function.

Referring to FIG. 2, the effect of a failure of the print production associated with the third function 215 on the performance of the second function 210 may be influenced by the processing rate and/or the buffer size of the print production device associated with the first function 205. For example, if the print production device associated with the first function 205 has a slow processing rate and a large buffer capacity, the effect of the failure of the print production device associated with the third function 215 on the print production device associated with the second function 210 may be minimal. In contrast, if the first function 205 has a fast processing rate and a small buffer capacity, the effect of the failure of the print production device associated with the third function 215 on the print production device associated with the second function 210 may be significant.

In an embodiment, a modification may be performed 320 on the production line. The implementation of the modification may reduce the effect of the delay condition on an upstream print production device and/or function. In an embodiment, a modification may include increasing a buffer size of a print production device. For example, if there is a delay in a function sequence, the buffer size associated with one or more print production devices may be increased so that processing does not need to stop.

In an embodiment, the processing rate of a print production device may be adjusted to compensate for the delay condition. For example, the processing rate of an upstream print production device may be adjusted. For example, if a buffer of a downstream print production device is significantly empty, the processing speed of an upstream print production device may be increased.

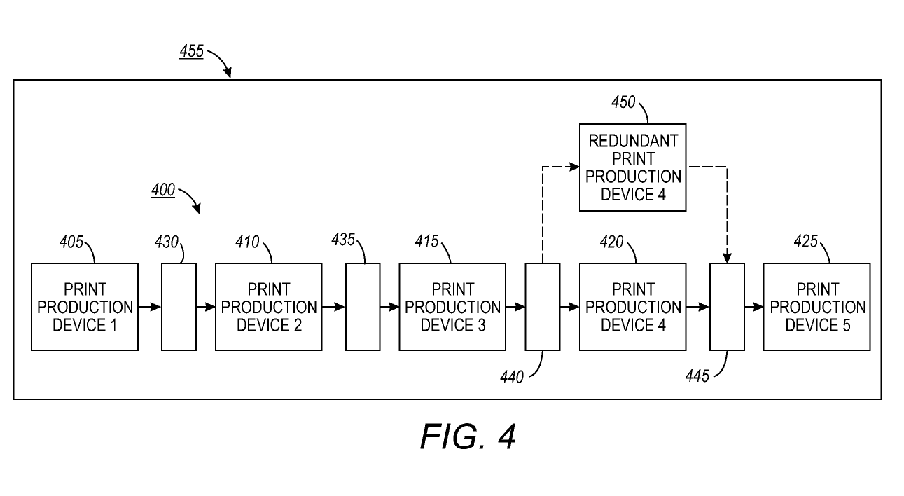

In an embodiment, processing may be switched to a redundant downstream print production device. In an embodiment, a redundant print production device may be one that may be substituted for one or more print production devices in a production line. A redundant print production device may serve as a backup should one or more devices in a production line malfunction. For example, FIG. 4 illustrates an exemplary production line 455 having five print production devices 405, 410, 415, 420, 425 and four buffers 430, 435, 440, 445. In an embodiment, a redundant print production device 450 may be associated with the fourth print production device 420. If the fourth print production device 420 becomes inoperable, the redundant print production device 450 may perform the fourth print production device's function on the print job. For example, the redundant print production device 450 may receive at least a portion of a print job from the buffer 440 associated with the third print production device 415, and may send the processed print job to a buffer 445 associated with the fourth print production device 420, the fifth production device 425 and/or the like. The use of a redundant print production device may reduce the effect of a malfunction of a downstream device (the fourth print production device) on an upstream device (the first, second and/or third print production device) because the print job processing may continue. Alternatively, another print production device may be added to a production line.

In an embodiment, a report may be generated. The report may include a description of one or more of the print production devices in a production line, characteristics of one or more print jobs, delay conditions associated with one or more of the print production devices, one or more effects of a delay condition on an upstream print production device, one or more modifications that were performed on the production line and/or the like. In an embodiment, the report may be displayed to a user of a production line.

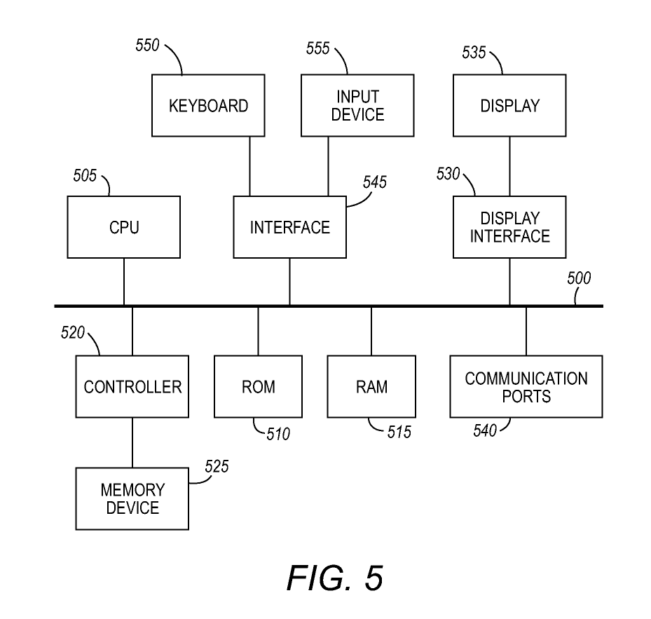

FIG. 5 depicts a block diagram of exemplary internal hardware that may be part of a computing device that contains or implements program instructions according to an embodiment. A bus 500 serves as the main information highway interconnecting the other illustrated components of the hardware. CPU 505 is the central processing unit of the system, performing calculations and logic operations required to execute a program. Read only memory (ROM) 510 and random access memory (RAM) 515 constitute exemplary computer-readable storage media that serve as memory devices.

A controller 520 interfaces with one or more optional additional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices.

Program instructions may be stored in the ROM 510 and/or the RAM 515. Optionally, program instructions may be Stored on a tangible computer readable medium such as a compact disk, a digital disk, flash memory, a memory card, a USB drive, an optical disc storage medium, such as Blu-ray™ disc, and/or other recording medium.

An optional display interface 530 may permit information from the bus 500 to be displayed on the display 535 in audio, visual, graphic or alphanumeric format. Communication with external devices may occur using various communication ports 540. An exemplary communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

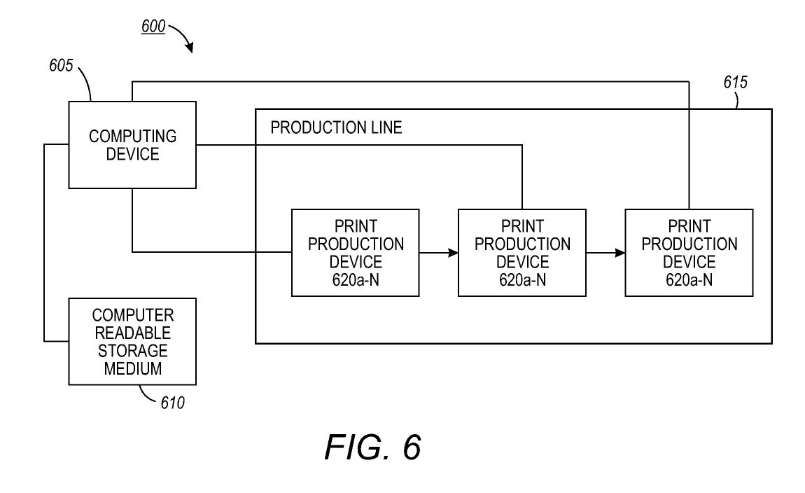

FIG. 6 illustrates an exemplary system for processing a print job according to an embodiment. As illustrated by FIG. 6, a system 600 may include a computing device 605, a computer-readable storage medium 610 and one or more print production devices 620a-N in a production line 615. The computer-readable storage medium 610 may include one or more programming instructions for processing a print job. In an embodiment, one or more of the print production devices 620a-N in the production line 615 may be in communication with the computing device 605.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for processing a print job in a print production environment, the system comprising:
a plurality of print production devices in a production line;
a computing device in communication with the one or more print production devices; and
a computer readable storage medium in communication with the computing device, wherein the computer readable storage medium comprises one or more programming instructions for:
identifying a processing rate and a buffer size for a first upstream print production device in the production line, wherein the first upstream print production device is associated with a first upstream function,
determining an effect on a second upstream print production device in the production line if a downstream print production device associated with a downstream function exhibits a delay condition, wherein the second upstream print production device is associated with a second upstream function, wherein the effect is influenced by the processing rate and the buffer size of the first upstream print production device, and
performing a modification to the production line such that implementation of the modification reduces the effect.

2. The system of claim 1, wherein the one or more programming instructions for determining a processing rate and a buffer size for a first upstream print production device comprise one or more programming instructions for receiving one or more of the processing rate and the buffer size from the first upstream print production device.

3. The system of claim 1, wherein the one or more programming instructions for determining a processing rate and a buffer size for a first upstream print production device comprise one or more programming instructions for receiving one or more of the processing rate and the buffer size from a user.

4. The system of claim 1, wherein the one or more programming instructions for determining an effect comprise one or more programming instructions for determining one or more delay conditions associated with the downstream print production device.

5. The system of claim 4, wherein the one or more programming instructions for determining one or more delay conditions comprise one or more programming instructions for:
determining a type associated with the downstream print production device; and
determining one or more delay conditions based on the type.

6. The system of claim 4, wherein the one or more programming instructions for determining one or more delay conditions comprise one or more programming instructions for determining one or more delay conditions based on the downstream function.

7. The system of claim 4, wherein the one or more programming instructions for determining one or more delay conditions comprise one or more programming instructions for:
determining historical data associated with the downstream print production device; and
determining one or more delay conditions based on the historical data.

8. The system of claim 4, wherein the one or more programming instructions for determining one or more delay conditions comprise one or more programming instructions for:
determining historical data associated with the downstream function; and
determining one or more delay conditions based on the historical data.

9. The system of claim 1, wherein the one or more programming instructions for performing a modification comprise one or more programming instructions for increasing a buffer size of a buffer associated with the second upstream print production device.

10. The system of claim 1, wherein the one or more programming instructions for performing a modification comprise one or more programming instructions for incorporating a redundant print production device in place of the downstream print production device.

11. The system of claim 1, wherein the one or more programming instructions for performing a modification comprise one or more programming instructions for adjusting the processing rate of one or more of the first upstream print production device and the second upstream print production device.

12. The system of claim 1, wherein the one or more programming instructions for performing a modification comprise one or more programming instructions for incorporating an additional print production device into the production line.

13. A method of processing a print job in a print production environment, the method comprising:
identifying a processing rate and a buffer size for a first upstream print production device in a production line, wherein the first upstream print production device is associated with a first upstream function;
determining an effect on a second upstream print production device associated with a second upstream function if a downstream print production device associated with a downstream function exhibits a delay condition, wherein the effect is influenced by the processing rate and the buffer size of the first upstream print production device; and
performing a modification to the production line such that implementation of the modification reduces the effect.

14. The method of claim 13, wherein determining a processing rate and a buffer, size for a first upstream print production device comprises receiving one or more of the processing rate and the buffer size from the first upstream print production device.

15. The method of claim 13, wherein determining a processing rate and a buffer size for a first upstream print production device comprises receiving one or more of the processing rate and the buffer size from a user.

16. The method of claim 13, wherein determining an effect comprises determining one or more delay conditions associated with the downstream print production device.

17. The method of claim 16, wherein determining one or more delay conditions comprises:
determining a type associated with the downstream print production device; and
determining one or more delay conditions based on the type.

18. The method of claim 16, wherein determining one or more delay conditions comprises determining one or more delay conditions based on the downstream function.

19. The method of claim 16, wherein determining one or more delay conditions comprises:
determining historical data associated with the downstream print production device; and
determining one or more delay conditions based on the historical data.

20. The method of claim 16, wherein determining one or more delay conditions comprises:
determining historical data associated with the downstream function; and
determining one or more delay conditions based on the historical data.

21. The method of claim 13, wherein performing a modification comprises increasing a buffer size of a buffer associated with the second upstream print production device.

22. The method of claim 13, wherein performing a modification comprises incorporating a redundant print production device in place of the downstream print production device.

23. The method of claim 13, wherein performing a modification comprises adjusting the processing rate of one or more of the first upstream print production device and the second upstream print production device.

24. The method of claim 13, wherein performing a modification comprises incorporating an additional print production device into the production line.
